(19) United States
(12) Patent Application Publication
(10) Pub. No.: US 2009/0145354 A1
(43) Pub. Date: Jun. 11, 2009

(54) MICRODROPLET COATER

(75) Inventor: Yoshiaki Nakamura, Yokohama-shi (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/323,879

(22) Filed: Nov. 26, 2008

(30) Foreign Application Priority Data
Nov. 30, 2007 (JP) P2007-310684

(51) Int. Cl. B05C 5/00

(52) U.S. Cl. 118/300

(57) ABSTRACT

According to an aspect of the present invention, there is provided a microdroplet coater including: a container in which a substrate is placed; a coating solution discharge unit that is installed in the container and that processes a coating solution containing a solute and a solvent into microdroplets to discharge the microdroplets onto the substrate; and an atmosphere adjustment unit that adjusts an atmosphere in the container so that the solvent is prevented from evaporating.

### CROSS-REFERENCE TO RELATED APPLICATIONS

This application claims priority from Japanese Patent Application No. 2007-310684 filed on Nov. 30, 2007, the entire contents of which are incorporated herein by reference.

### BACKGROUND OF THE INVENTION

1. Field of the Invention

An aspect of the present invention relates to a microdroplet coater.

2. Description of the Related Art

Various techniques for measuring concentrations of electrolytes (such as potassium ion, sodium ion, and chlorine ion) in blood vessels have been proposed.

Among those techniques, an electrolyte concentration measurement apparatus using an ion-sensitive field-effect transistor (ISFET) sensor has the high measurement handleability, the high measurement sensitivity, the high measurement responsiveness and the low cost so as to be used disposably.

For example, such an ISFET is formed by applying a sensitive film including a sensitive agent showing a selective-sensitivity to a specific ion (such as, valinomycin of potassium ion) onto a gate of an n-channel FET (Field Effect Transistor) so as to have a given thickness.

To form such a sensitive film, a coating solution containing a solute and a solvent is used. In the solute, a sensitive film constituent agent, a base material, such as Polyvinyl Chloride (PVC) and a plasticizer, such as Dioctyl Adipate (DOA) are blended in a given ratio. The sensitive film constituent agent is dissolved in the solvent, such as Tetrahydrofuran (THF). The solution is applied onto a gate of a FET, and thereafter, the solvent is made to vapor, thereby forming the sensitive film.

A thickness of the sensitive film is required to be uniform in a substrate plane in order to improve the reliability of the sensor and the reproducibility of measurement data.

A spin coat method has been used for coating a sensitive film to have uniform thickness. However, in a spin coat method, the use efficiency of a coating solution is low.

Then, a technique to selectively apply a coating solution onto a gate of an ISFET by using a so-called inkjet coating method in which microdroplets are ejected from microchannels.

Because an inkjet coating method is capable of applying droplets only onto a target area (for example, a gate of an ISFET), the use efficiency of a coating material is high and environmental load, which has become a subject of discussion in recent years, is small. Moreover, a thickness of a coating film can be controlled in accordance with an integral coating solution discharge rate from a nozzle. Although depending on a coating range, when an inkjet nozzle has minimum droplet discharge rate from the nozzle is on the order of picoliters and a target range is φ5 mm, for example, a thickness of the coating film can be controlled on the order of several tens of nanometers.

However, in an inkjet coating method, a coating solution easily blocks up a nozzle, thereby necessitating the frequent maintenance on the nozzle and deteriorating a productivity (JP-2007-050701-A).

### SUMMARY OF THE INVENTION

According to an aspect of the present invention, there is provided a microdroplet coater including: a container in which a substrate is placed; a coating solution discharge unit that is installed in the container and that processes a coating solution containing a solute and a solvent into microdroplets to discharge the microdroplets onto the substrate; and an atmosphere adjustment unit that adjusts an atmosphere in the container so that the solvent is prevented from evaporating.

According to another aspect of the present invention, there is provided a microdroplet coater including: a container in which a substrate is placed; a coating solution discharge section that is installed in the container and that processes a coating solution containing a solute and a solvent into microdroplets to discharge the microdroplets onto the substrate; a solution spray section that is installed in the container and that sprays the solvent; and a controller that controls the solution spray section to adjust an atmosphere in the container so that the solvent is prevented from evaporating.

### BRIEF DESCRIPTION OF THE DRAWINGS

FIG. 1 is a schematic diagram of a microdroplet coater according to a first embodiment of the present invention;

FIG. 2 is a perspective view of the microdroplet coater according to the first embodiment;

FIG. 3 is an operation flowchart for the microdroplet coater according to the embodiment;

FIG. 4 is a graph in which the THF atmosphere concentrations (wt %) in the closed container are plotted on the abscissa, and the solidification times of the coating solution are plotted on the ordinate;

FIG. 5 is a perspective view of a microdroplet coater according to a second embodiment of the present invention; and

FIG. 6 is a perspective view of a microdroplet coater according to a third embodiment of the present invention.

### DETAILED DESCRIPTION OF THE INVENTION

Hereinafter, embodiments of the present invention will be described with reference to the drawings.

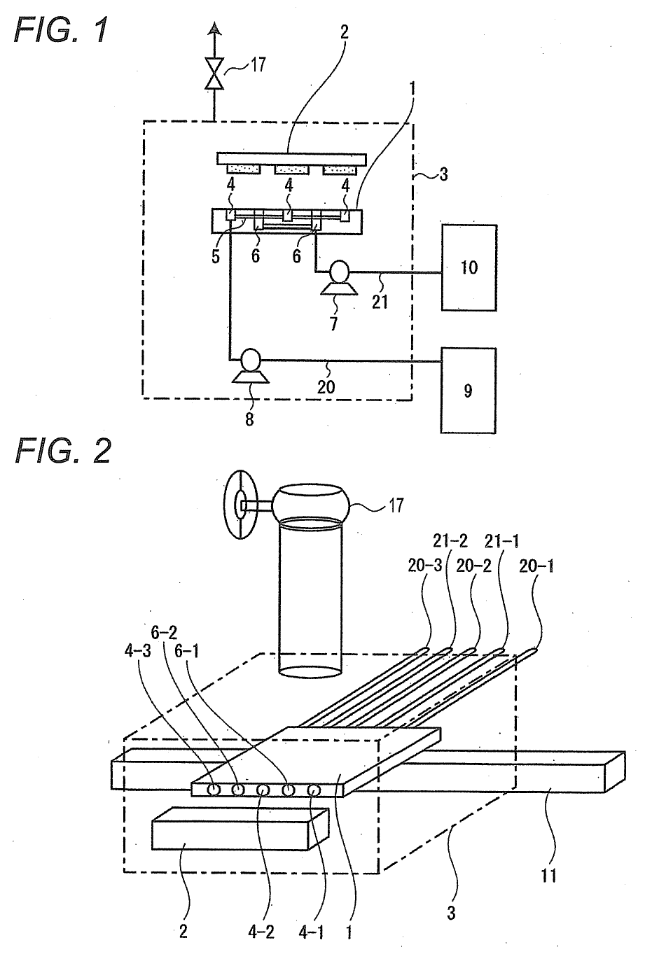

FIG. 1 is a block diagram schematically showing a microdroplet coater according to a first embodiment of the present invention. Further, FIG. 2 is a perspective view of the microdroplet coater.

As shown in FIG. 1, the microdroplet coater includes a container 3 shown by a chain line and a nozzle head 1 provided in the container 3. The nozzle head 1 includes microdroplet discharge nozzles 4 provided therein. The microdroplet discharge nozzles 4 are configured to process a coating solution including a solute and a solvent into microdroplets and to discharge those onto a target substrate 2 placed in the container 3. The microdroplet discharge nozzles 4 are connected to one another through a pipe 5 to be capable of simultaneously discharging microdroplets onto given areas on the target substrate 2. The microdroplet discharge nozzles 4 are connected to a coating solution container 9 provided outside the container 3 via a coating solution pump 8 with a pipe 20. The coating solution pump 8 is provided in the container 3 to control the supply pressure of a coating solution in the vicinity of the nozzle head 1. Because the coating solution pump 8 is located near the nozzle head 1, it is easy to control the supply pressure. In the coating solution container 9, the coating solution including the solute and the solvent is stored. The solute includes a sensitive film constituent agent corresponding to a measured ion, PVC serving as a base material for a sensitive film and DOA serving as a plasticizer. The solute is mixed to THF serving as the solvent in a given ratio.

The nozzle head 1 further includes solvent spray nozzles 6 therein. The solvent spray nozzles 6 are configured to spray a solvent in order to keep an atmosphere inside the container 3 so that the solvent is prevented from vaporizing. The solvent spray nozzles 6 are connected to a solvent container 10 provided outside the container 3 via the solvent pump 7 with a pipe 21. The solvent pump 7 is provided in the container 3 to control the supply pressure of the solvent to be sprayed in the vicinity of the nozzle head 1. Because the solvent pump 7 is located near the nozzle head 1, it is easy to control the supply pressure. THF used as a solvent is stored in the solvent container 10.

A valve 17 is provided to the container 3 to exhaust air from thereinside. When the target substrate 2 is taken out of the coater after the coating process, the air inside the container 3 is exhausted to be rendered harmless, and thereafter, the air is discharged outside. That is, when performing the coating, in the microdroplet coater, the nozzle head 1 and the target substrate 2 are stored in the container 3 to be blocked off from the outside air by closing the valve 17. After the coating, the valve 17 is opened, the solvent atmosphere is rendered harmless by a discharge-air processing apparatus (not shown) capable of processing the solvent atmosphere, and the target substrate 2 on which the ISFETs are formed is taken out through the valve 17.

In the microdroplet coater, the microdroplet discharge nozzles 4 are provided at three places in the nozzle head 1 corresponding to the number of coating target areas on the target substrate 2, and the microdroplet discharge nozzles 4 are connected to one another via the channel 5 in the nozzle head 1 so that the discharging of the coating solution is controlled by one coating solution pump 8. With this structure, it is possible to improve the processing efficiency.

In this nozzle head 1, the solvent spray nozzles 6 to adjust the atmosphere in the container 3 are provided in the same plane between the microdroplet discharge nozzles 4. The blockage of the nozzle head 1 tend to occur especially at the leading ends of the microdroplet discharge nozzles 4. With the above structure, since a concentration of the solvent atmosphere near the leading ends of the microdroplet discharge nozzles 4 can be kept high, the solvent included in the coating solution is effectively prevent from vaporizing, thereby preventing the blockage. For example, each element of the microdroplet coater shown in FIG. 1 is controlled by a controller (not shown).

FIG. 2 is a perspective view for further concrete explanation of the nozzle head 1.

As shown in FIG. 2, the nozzle head 1, a rail 11 along which the nozzle head 1 is moved, and the target substrate 2 are disposed in the container 3 shown by the chain line. The valve 17 to exhaust air to the outside is provided to the container 3.

Microdroplet discharge nozzles 4-1, 4-2, and 4-3 are provided in the nozzle head 1, and solution supply pipes 20-1, 20-2, and 20-3 are connected respectively thereto.

Further, in the nozzle head 1, a solvent spray nozzle 6-1 is provided between the microdroplet discharge nozzles 4-1 and 4-2, a solvent spray nozzle 6-2 is provided between the microdroplet discharge nozzles 4-2 and 4-3, and solvent supply pipes 21-1 and 21-2 are connected respectively thereto.

The microdroplet discharge nozzles 4-1, 4-2, and 4-3 and the solvent spray nozzles 6-1 and 6-2 are disposed so as to be aligned and to face the target substrate 2.

Although not shown in the figure, the solution pump 8 and a solvent pump 7 shown in FIG. 1 are provided inside the nozzle head 1. The sensitive-film-material coating solution is discharged for a given time, at a given discharge pressure and at a given discharge rate, along the determined operation procedure.

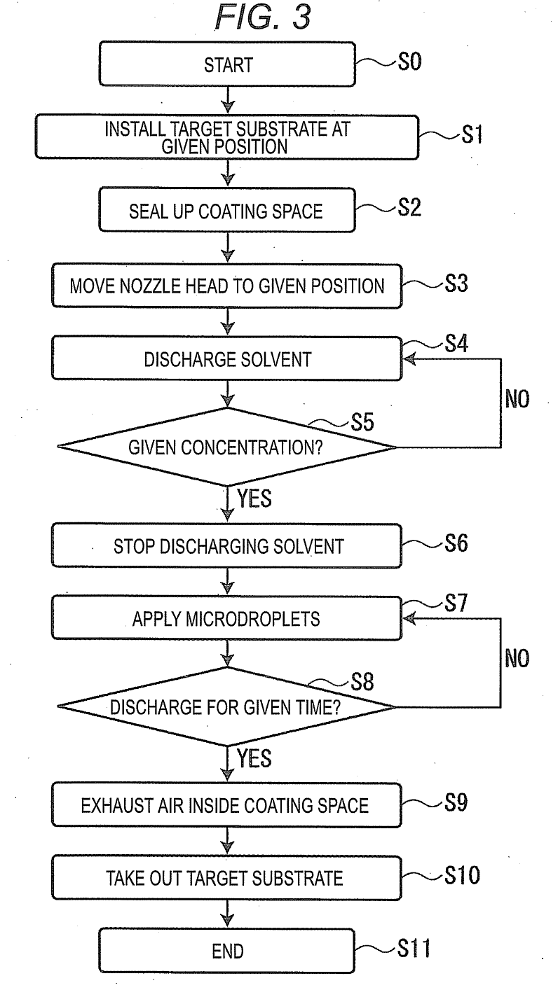

FIG. 3 is an operation flowchart for the microdroplet coater.

First, as shown in FIG. 3, the target substrate 2 is installed at a given position in the container 3 of the microdroplet coater (S1).

Next, the coating space is sealed up by closing the valve 17 of the container 3 (S2).

Next, the nozzle head 1 is moved so as to face the target substrate 2 and so that the microdroplet discharge nozzles 4-1, 4-2, and 4-3 face the coating areas on the target substrate 2 (S3).

Next, the solvent pump 7 is operated to discharge the solvent from the solvent spray nozzles 6-1 and 6-2 (S4).

Next, a solvent concentration in the container 3 is measured by a sensor or the like disposed in the container 3. When the solvent concentration is kept within a given range, the routine proceeds to S6. When the solvent concentration is not kept within the range, the routine returns to S4.

When the solvent concentration is kept within the given range at S5, the solvent pump 7 is stopped to stop discharging the solvent from the solvent spray nozzles 6-1 and 6-2 (S6).

Next, the solution pump 8 is operated to process the solution into microdroplets from the microdroplet discharge nozzles 4-1, 4-2, and 4-3 to be applied onto the substrate 2 (S7).

Next, it is determined whether or not the microdroplets are applied thereto for a given time, and when the time is insufficient, the routine returns to S7, and when the given time has elapsed, the routine proceeds to S9.

When the coating is performed for the given time, the valve 17 is opened to exhaust the air from the container 3 (S9).

Next, the target substrate 2 on which the ISFETs are formed is taken out (S10), and the processing is completed (S11).

As described above, the container 3 in which the microdroplet discharge nozzles 4-1, 4-2, and 4-3 are exposed is filled with the solvent atmosphere. Therefore, a time for which the solvent included in the solution from the microdroplet discharge nozzles 4-1, 4-2, and 4-3 are evaporated can be lengthened. Since the solution is not dried in the microdroplet discharge nozzles 4-1, 4-2, and 4-3, the nozzle blockage can be prevented, and the maintenance of nozzles can be reduced as compared with the conventional coater, thereby improving the operation rates of the coater.

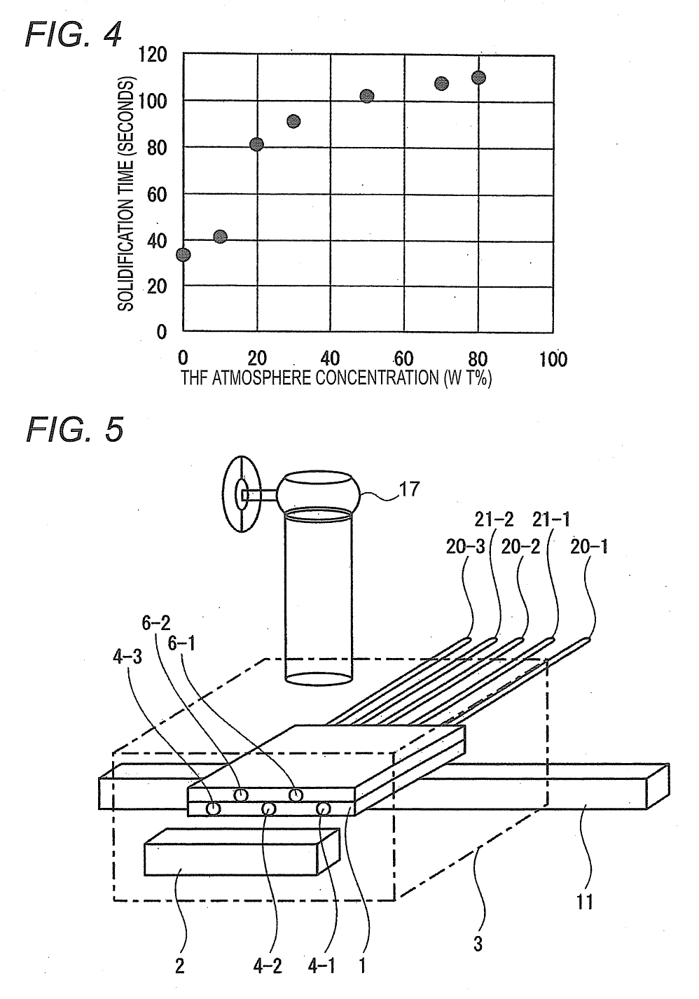

FIG. 4 is a graph in which the THF atmosphere concentrations (wt %) in the closed container are plotted on the abscissa, and the solidification times of the coating solution are plotted on the ordinate.

Here, the coating solution of 1 cc in which THF is used as a solvent is put in the container having a diameter of 1 cm, and a relationship with a solidification time of the coating solution while varying a THF solvent concentration in the atmosphere has been determined.

It can be understood from FIG. 4 that the higher the solvent concentration (THF atmosphere concentration) included in the atmosphere in the closed container is, the longer the solidification time of the coating solution is, and an amount of solvent evaporation is gradually decreased.

Further, it can be understood from FIG. 4 that the solidification time of the coating solution is approximately 80 seconds when a solvent concentration is 20 percent, which is approximately double the time of approximately 40 seconds when the solvent concentration is less than 20 percent. It can be understood from this result that, when the solvent concentration is kept to be greater than or equal to 20 percent and less than or equal to 100 percent, the solution becomes difficult to solidify, thereby preventing nozzle blockage.

Although, THF is exemplified as a solvent, the solvent is not limited thereto, and even if another solvent is used, such a tendency is brought about.

FIG. 5 is a perspective view of a microdroplet coater according to a second embodiment of the present invention. Portions which are the same as those in FIG. 2 are denoted by the same reference numerals, and descriptions thereof will be omitted.

As shown in FIG. 5, in the microdroplet coater, the microdroplet discharge nozzles 4-1, 4-2, and 4-3 and the solvent spray nozzles 6-1 and 6-2 are formed in separate nozzle heads, and the nozzle heads are laminated and connected integrally. Although the microdroplet discharge nozzles 4-1, 4-2, and 4-3 and the solvent spray nozzles 6-1 and 6-2 are disposed alternately, the lines thereof are displaced from one another. Such displacement does not impair the advantageous effect of the embodiments.

Because the microdroplet discharge nozzles 4-1, 4-2, and 4-3 and the solvent spray nozzles 6-1 and 6-2 are formed in the separate nozzle heads, the respective nozzles can be independently washed or replaced at the time of maintenance, which is convenient.

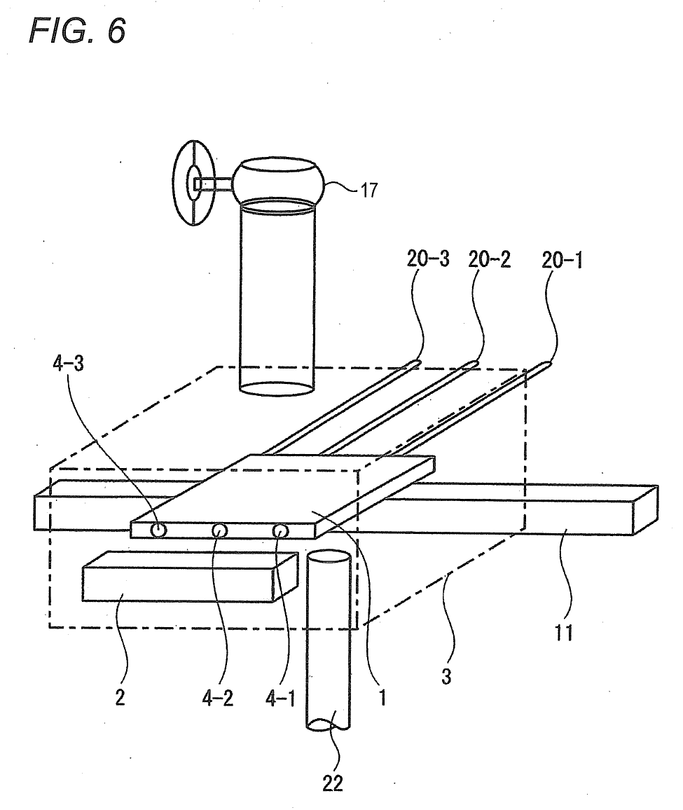

FIG. 6 is a perspective view of a microdroplet coater according to a third embodiment of the present invention. Portions which are the same as those in FIG. 2 are denoted by the same reference numerals, and descriptions thereof will be omitted.

As shown in FIG. 6, instead of the solvent spray nozzles 6 (FIG. 2) provided in the nozzle head 1, a solvent supply pipe 22 is provided to the container 3 to produce the solvent atmosphere. At this time, an amount of a solvent supplied from the pipe 22 is se to be greater than or equal to a volume in the container 3. The valve 17 may be opened during supplying the solvent from the supply pipe 22 to control the solvent concentration in the container 3 in a steady state. It is clear that the advantageous effect of the embodiments can be obtained in this way as well.

According to an aspect of the present invention, provided that an atmosphere in a container is controlled so as to be difficult to dry a solvent of a coating solution, it is possible to prevent nozzle blockage.

What is claimed is:

1. A microdroplet coater comprising:
a container in which a substrate is placed;
a coating solution discharge unit that is installed in the container and that processes a coating solution containing a solute and a solvent into microdroplets to discharge the microdroplets onto the substrate; and
an atmosphere adjustment unit that adjusts an atmosphere in the container so that the solvent is prevented from evaporating.

2. The microdroplet coater according to claim 1,
wherein the coating solution discharge unit includes a coating solution discharge nozzle in which micropores are formed at an leading end thereof, and
wherein the coating solution discharge unit processes the coating solution into the microdroplets by discharging the coating solutions through the micropores.

3. The microdroplet coater according to claim 1,
wherein the atmosphere adjustment unit includes a solvent spray nozzle formed to spray a solvent, and
wherein the atmosphere adjustment unit adjusts the atmosphere in the container by spraying the solvent that is the same type as the solvent of the coating solution inside the container.

4. The microdroplet coater according to claim 1,
wherein the atmosphere adjustment unit adjusts the atmosphere in the container so that a concentration of the solvent is greater than or equal to 20 percent and less than or equal to 100 percent.

5. A microdroplet coater comprising:
a container in which a substrate is placed;
a coating solution discharge section that is installed in the container and that processes a coating solution containing a solute and a solvent into microdroplets to discharge the microdroplets onto the substrate;
a solution spray section that is installed in the container and that sprays the solvent; and
a controller that controls the solution spray section to adjust an atmosphere in the container so that the solvent is prevented from evaporating.
